(19) United States
(12) Patent Application Publication
(10) Pub. No.: US 2022/0250942 A1
(43) Pub. Date: Aug. 11, 2022

(54) REACTOR ALLOWING THE CONTINUOUS FILTRATION OF LIQUID FLOWING THROUGH A FILTER WITH IN SITU ELECTROCHEMICAL REGENERATION OF THE FILTER

(71) Applicant: UNIVERSITÉ GUSTAVE EIFFEL, Champs-sur-Marne (FR)

(72) Inventors: Clement TRELLU, Bry-sur-Marne (FR); Nihal OTURAN, Villiers sur Marne (FR); Yoan PECHAUD, Clamart (FR); Mehmet A. OTURAN, Villiers sur Marne (FR)

(73) Assignee: UNIVERSITÉ GUSTAVE EIFFEL, Champs-sur-Marne (FR)

(21) Appl. No.: 17/592,692

(22) Filed: Feb. 4, 2022

(30) Foreign Application Priority Data
Feb. 5, 2021 (FR) 2101151

(51) Int. Cl. C02F 1/28; C02F 1/00; C25B 15/08

(52) U.S. Cl. CPC C02F 1/283; C02F 1/008; C02F 2101/30; C02F 2303/16; C02F 2209/003; C25B 15/081

(57) ABSTRACT

Reactor allowing the continuous filtration of a flowing fluid for the adsorption of pollutants on a filter, and electrolysis for regeneration of the filter and removal of organic pollutants, the reactor having a chamber, with at least one inlet delivering a fluid into the chamber and at least one outlet for evacuating the fluid from the chamber; a circuit for circulating a fluid to be treated by adsorption of pollutants on the filter; a circuit for recirculating an electrolyte solution for electrolysis, connecting the outlet to the inlet; the reactor operating in two modes; in continuous filtration mode of a fluid through the circulation circuit for adsorption of pollutants on the filter; in electrolysis mode for regeneration of the filter and removal of organic pollutants, by applying an electric current, with continuous recirculation of the electrolyte solution through the recirculation circuit.

### FIELD OF INVENTION

The present invention concerns a reactor allowing the continuous frontal filtration of a flowing fluid for adsorption of pollutants on a filter and electrolysis for the in situ electrochemical regeneration of the filter and removal of organic pollutants.

### STATE OF THE ART

The development of sustainable water treatment systems achieving high rates of micropollutant removal is a significant challenge for environmental engineering. Activated carbon (AC) is currently widely used in water treatment plants, as it has proven to be an effective adsorbent for the removal of organic compounds from water. This is due to its large specific surface area, internal microporosity as well as the presence of large amounts of various surface functional groups. This material is also widely used in air treatment.

However, activated carbon only allows the separation of pollutants by the adsorption of pollutants on its surface; it does not allow their degradation.

Activated carbon is loaded/saturated with organic pollutants and becomes a waste product, which must be treated. Ideally, treatment should lead to both regeneration/reuse of granular activated carbon (in order to improve the durability and cost-effectiveness of the process) and degradation of organic pollutants (in order to prevent environmental contamination).

While the efficiency and adsorption mechanisms of a wide range of organic compounds on various activated carbon materials (grains, powders, fibers) have already been widely reported in the literature, there is still a need to develop innovative and efficient processes for the regeneration of spent/saturated/pollutant-loaded activated carbon.

Thermal regeneration is the most widely used process. Efficiency depends closely on the nature of the adsorbed compounds and the nature of interactions with the activated carbon surface. Thermal regeneration with an inert atmosphere often leads to lowered adsorption capacity, due to insufficient removal of chemisorbed compounds. In addition, additional treatment is normally required for the degradation of desorbed pollutants. Higher removal rates are achieved during thermal treatment under oxidizing conditions, but the microporous structure of the activated carbon is strongly affected. Moreover, thermal processes are expensive. They require the installation of centralized regeneration units, requiring the activated carbon to be transported from the pollution control units to the material regeneration units.

On the other hand, electro-oxidation processes (anodic oxidation, electro-Fenton) allow for the complete degradation of organic pollutants, up to complete mineralization. However, their disadvantage lies in their poor energy efficiency when used for the treatment of low concentrated effluents, as is the case in wastewater treatment plants and drinking water plants.

Chemical regeneration by oxidation, using for example ozone or the Fenton reaction, can also strongly affect the chemical and textural characteristics of activated carbon. In addition, poor regeneration efficiency is often observed for microporous activated carbons, and thus chemical regeneration is often applied only to mesoporous or non-porous materials.

Among the various forms of activated carbon, porous fibers have unique characteristics compared to granular or powdered activated carbon. The fine fiber form and associated open porosity reduces intraparticle diffusion resistance and gives this material mechanical and geometric characteristics adapted to the design of electrochemical reactors.

Activated carbon is an effective material for the adsorption of organic compounds and can be polarized as a cathode, especially for the electrochemical generation of H₂O₂ during water treatment. Compared to granular activated carbon beds, porous activated carbon fibers provide a better level of interconnection in terms of microstructure and thus reduce ohmic drops as well as dead zones (non-electroactive areas) when used as an electrode. Their open porosity also allows for improved adsorption kinetics. It is thus possible to implement activated carbon beds with a smaller thickness and/or to use a higher filtration speed.

The regeneration process is an electrolysis process, more precisely an electro-oxidation process, for which batch reactor applications are widely known. The possibility of passing the solution to be treated through the anode and cathode materials in frontal filtration mode, during the electro-oxidation process, is not described in the literature. Regarding electrochemical regeneration studies, few studies focus on the use of activated carbon fibers. Many studies do not use activated carbon electrodes either. Activated carbon is often only placed in the electrolyte solution. In addition, many studies on electrochemical regeneration only outline scenarios that do not involve degradation and mineralization of organic compounds adsorbed by the filter (only the desorption phenomenon is described). As already mentioned, studies do not describe systems that allow the electrolyte solution to pass successively through the filter (used as a cathode) and the counter-electrode (the anode), during electrochemical regeneration. The more specialized publications relating to regeneration by electro-oxidation of activated carbon fibers only report results in batch reactors.

For example, the paper by J. A. Bañuelos, F. J. Rodriguez et al. [Novel Electro-Fenton Approach for Regeneration of Activated Carbon, Environmental Science & Technology. 47 (2013) 7927-7933] presents an electro-Fenton-based method used to promote the regeneration of granular activated carbon (GAC) previously adsorbed with toluene. The paper presents electrochemical regeneration experiments carried out using a batch-type electro-Fenton device for adsorption and regeneration. A standard three-electrode laboratory electrochemical cell was used, with carbon paste (cathode) and platinum (anode) electrodes.

To overcome the disadvantages of the state of the art, an activated carbon regeneration process was developed to remove pollutants accumulated on the saturated activated carbon, through an electrolysis process often called electro-oxidation or anodic oxidation, using saturated activated carbon fibers as the cathode, and a boron-doped diamond or sub-stoichiometric titanium oxide anode, described for a batch-type device, in patent application WO 2019/175038 A1. The device allows two steps to be carried out in the same reactor: adsorption and regeneration/removal of pollutants. The device allows the electrolyte solution to pass successively through the filter used as a cathode as well as through the anode material, during the electrochemical regeneration step.

### DISCLOSURE OF THE INVENTION

The major challenge in this field is to move beyond batch reactors and to develop a process that can be implemented continuously in a reactor wherein both filtration and, in targeted fashion, regeneration can occur, through electro-oxidation of the filter used and removal of desorbed pollutants. The challenges include implementation of the regeneration process inside a reactor which must be closed and within which flow is required through the filter and the electrode materials used for regeneration/removal of pollutants.

One object of the invention is to provide a reactor that allows both the adsorption step (continuous filtration) and the regeneration/removal step of desorbed pollutants to be performed in situ, minimizing operator intervention and eliminating the need to transport the filter out of the reactor for regeneration. The objective of such a reactor is to allow not only a separation of pollutants during the adsorption step, but also a removal (degradation and mineralization) of organic pollutants during the regeneration step.

The invention includes a reactor for the continuous frontal filtration of a flowing fluid for adsorption of pollutants on a filter and electrolysis for regeneration of the filter and removal of organic pollutants, the reactor comprising:
a chamber, with at least one inlet delivering a fluid into the chamber and at least one outlet for discharging the fluid from the chamber;
means for supplying electric current;
a circuit for circulating a fluid to be treated by adsorption of pollutants on the filter, allowing the passage of the fluid to be treated through the chamber;
a circuit for recirculating an electrolyte solution for electrolysis, connecting the outlet to the inlet, and passing through an open buffer volume allowing the evacuation of gas bubbles generated during electrolysis;
a fluid transport system;
   all the fluid to be treated as well as the electrolyte solution pass successively through all the elements of the chamber which comprises at least:
a porous filter having at least one activated carbon layer allowing the adsorption of organic pollutants during the flow of fluid to be treated,
   the layer(s) being electrically connected to the electrical power supply, in order to polarize them only during electrolysis, the filter being the cathode during electrolysis and the passage of the electrolyte solution allowing regeneration of the filter and removal of organic pollutants;
an anode, upstream or downstream of the filter, comprising at least one layer of anode material and openings allowing the flow of fluid during filtration and the flow of electrolyte solution during electrolysis, the material being electrically connected to the electrical power supply, in order to polarize it as an anode during electrolysis and remove desorbed organic pollutants from the filter,
   the anode and the filter are placed horizontally within the vertically positioned chamber, the recirculation circuit ensuring an upward flow of the electrolyte solution within the chamber, in order to facilitate the evacuation of gas bubbles formed during electrolysis;
   the reactor operating in two modes:
in continuous filtration mode of a fluid through the circulation circuit for adsorption of pollutants on the filter, without an electrical power supply, without water recirculation,
in electrolysis mode, for regeneration of the filter and removal of organic pollutants, by applying an electric current between the filter used as a cathode and the anode, with continuous recirculation of the electrolyte solution through the recirculation circuit.

In various embodiments, one or all of the following features, taken alone or in combination, may be provided.

Advantageously, the anode comprises a perforated material or a mesh screen on which the anode material is deposited.

Advantageously, when an electrode placed downstream of another electrode relative to the direction of fluid flow during regeneration is:
the anode, thus comprising a perforated material or a mesh screen with openings/mesh greater than 0.15 cm² allowing the passage of gas bubbles formed during electrolysis; or
the filter used as a cathode, the fluid transport system is thus configured to exert pressure on this downstream electrode, thereby enabling the passage of gas bubbles formed during electrolysis, through this downstream electrode.

Advantageously, the reactor comprises an anode material made of boron-doped diamond or sub-stoichiometric titanium oxide allowing the removal of organic compounds.

Advantageously, at least one activated carbon layer is formed of activated carbon fibers.

Advantageously, at least one activated carbon layer is formed of granular activated carbon.

Advantageously, the chamber comprises several anode/filter pairs, connected in series, the two faces of an electrode being polarizable during electrolysis.

Advantageously, at least one anode, at least one cathode and the electrical power supply are included in the open buffer volume, in order to facilitate the removal of pollutants during electrolysis, such as an anode comprising at least one layer of boron-doped diamond or sub-stoichiometric titanium oxide.

Advantageously, the pH of the electrolyte solution is adjusted to a pH higher than 9, in order to promote the desorption of pollutants during electrolysis.

Advantageously, the reactor comprises a control unit connected to solenoid valves in the circulation and recirculation circuits, to the fluid transport system and the electrical power supply, so as to be able to activate the filtration or electrolysis operating mode, by action of the control unit on the circulation and recirculation circuits as well as on the fluid transport system and the electrical power supply.

Advantageously, the fluid transport system is configured to allow the recirculation circuit to reach a fluid filtration rate through the filter greater than 2 m/h.

Advantageously, the control unit is able to reverse the direction of the circulation flow in the reactor between the passage of fluid in the reactor in filtration mode, and the passage of electrolyte solution in electrolysis mode.

Advantageously, the control unit is connected to a sensor for measuring the concentration of pollutants at the outlet, the electrolysis mode being activated when the pollutant concentration goes above a given value, the filtration mode being activated when the pollutant concentration goes below a given value.

Advantageously, the fluid is a gas or a liquid such as an aqueous liquid.

The invention also includes a system previously described comprising multiple reactors.

In various embodiments, one or all of the following features, taken alone or in combination, may be provided.

Advantageously, the fluid recirculation circuits in the reactors are connected so as to provide a shared open buffer volume.

Advantageously, the reactors are placed in series or in parallel with respect to the flow of the fluid to be treated.

### DESCRIPTION OF THE DRAWINGS

Other objectives, features and advantages will emerge from the following detailed description, with reference to drawings which are non-limiting and given by way of illustration, among which:

FIG. 1a shows a cross-sectional diagram of a reactor used in adsorption mode;

FIG. 1b shows a cross-sectional diagram of a reactor used in regeneration mode;

FIG. 2 shows an experimental assembly of the reactor, seen from above;

FIG. 3 shows an experimental assembly of the reactor, seen from the side;

FIG. 4 shows the reactor in separate parts, seen from above;

FIG. 5 is a diagram of a system comprising several reactors in parallel, operating either in adsorption or regeneration mode, such that the flow of water is continuous;

FIG. 6 is a diagram of a system comprising several reactors in series, operating either in adsorption or regeneration mode, such that the flow of water is continuous and regulated by a control unit using sensors;

FIG. 7 shows the adsorption rate of a virgin filter and of non-regenerated filters, over time;

FIG. 8 shows the adsorption rate of a virgin filter and of regenerated filters, over time;

FIG. 9 shows a diagram of the desorption of organic pollutants and their degradation;

FIG. 10 shows scanning electron microscope images of the initial activated carbon fabric (A, E) and after 10 regeneration cycles (B, F). Images C and D focus on the area of porous fiber breakage observed in the material after 10 regeneration cycles;

FIG. 11 shows a breakthrough curve of the activated carbon fiber filter for the removal of 50 mg/L clofibric acid by one layer of fiber (results shown as a triangle), 100 mg/L phenol by 8 layers of fiber (results shown as a circle), 100 mg/L phenol by 10 layers of fiber (results shown as a square). The ratio C/C₀ shows the ratio between the concentration at the filter outlet (C) and the initial concentration of the solution (C₀);

FIG. 12 shows the evolution of the total organic carbon (TOC) concentration in the solution, during regeneration cycles between each adsorption cycle;

FIG. 13 shows the evolution of the adsorption rate of phenol (sample pollutant) on activated carbon fibers (in g of phenol per g of activated carbon fibers), in relation to filtration time during two adsorption cycles of 290 min. (accelerated adsorption test). An electrochemical regeneration step is carried out in situ between the 2 cycles;

FIG. 14 shows the evolution of the concentration of total organic carbon (TOC) in the solution, during the regeneration cycle;

FIG. 15 shows an explanatory diagram of the problem of gas retention between electrodes during electrolysis;

FIG. 16 shows the evolution of cell potential difference (PD), in an activated carbon fiber bed (cathode)/tight mesh BDD screen (anode) configuration. The flow of the electrolyte solution through the electrodes is 1000 L/m⁻²/h⁻² (i.e., filtration rate of 1 m/h⁻¹);

FIG. 17 shows the evolution of cell potential difference (PD), in an activated carbon fiber bed (cathode)/tight mesh BDD screen (anode) configuration. The flow of the electrolyte solution through the electrodes is 5000 L/m⁻²/h⁻² (i.e., filtration rate of 5 m/h⁻¹);

FIG. 18 shows the evolution of cell potential difference (PD), in an activated carbon fiber bed (cathode)/tight or large mesh BDD screen (anode) configuration. The flow of the electrolyte solution through the electrodes is 1000 L/m⁻²/h⁻² (i.e., filtration rate of 1 m/h⁻¹);

FIG. 19 shows the evolution of cell potential difference (PD), in a tight mesh BDD screen (anode)/activated carbon fiber bed (cathode) configuration. The flow of the electrolyte solution through the electrodes is 1000 L/m⁻²/h⁻² (i.e., filtration rate of 1 m/h⁻¹) or 5000 L/m⁻²/h⁻² (i.e., filtration rate of 5 m/h⁻¹);

FIG. 20 shows the evolution of phenol concentration during regeneration of a 10-fiber saturated activated carbon filter (19.6 cm² surface area), by filtration of a 10-mg/L phenol solution at 2 L/h. A mesh BDD screen-type anode (large mesh size) is placed downstream of the filter, another one upstream. A BDD anode and a stainless steel cathode are placed in the buffer volume for recirculation. The current intensity is 300 mA in the buffer volume, and 300 mA in the chamber. The filtration rate of electrolyte solution is 5 m/h. The electrolyte solution contains 50 mM Na₂SO₄ and pH is adjusted to 13 With NaOH;

FIG. 21 shows the evolution of the total organic carbon (TOC) concentration during regeneration of a 10-fiber saturated activated carbon filter (surface area of 19.6 cm²), by filtration of a 10-mg/L phenol solution at 2 L/h. A mesh BDD screen-type anode (large mesh size) is placed downstream of the filter, another one upstream. A BDD anode and a stainless steel cathode are placed in the buffer volume for recirculation. The current intensity is 300 mA in the buffer volume, and 300 mA in the chamber. The filtration rate of electrolyte solution is 5 m/h. The electrolyte solution contains 50 mM Na₂SO₄ and pH is adjusted to 13 with NaOH;

FIG. 22 shows the evolution of the breakthrough curve for adsorption of 10 mg/L phenol at a flow rate of 2 L/h on a filter of 10 activated carbon fibers (surface area of 19.6 cm²), on the new filter and after regeneration. The operating conditions for regeneration are those indicated in FIGS. 20 and 21.

### DETAILED DESCRIPTION OF THE INVENTION

The invention provides a first embodiment, a reactor 1 allowing the continuous frontal filtration of a flowing fluid for adsorption of pollutants on a filter 2, and electrolysis for regeneration of the filter 2 and removal of organic pollutants,

the reactor 1 comprising:
a chamber 3, with at least one inlet 4 delivering a fluid into the chamber 3 and at least one outlet 5 for evacuating the fluid from the chamber 3;
means for supplying electric current;
a circulation circuit 8 of a fluid to be treated by adsorption of pollutants on the filter 2, allowing the passage of the fluid to be treated through the chamber 3;
a recirculation circuit 9 of an electrolyte solution for electrolysis, connecting the outlet 5 to the inlet 4, and passing through an open buffer volume 9a allowing the evacuation of gas bubbles generated during electrolysis;
a fluid transport system;
   all the fluid to be treated and the electrolyte solution passing successively through all the elements of the chamber 3 which comprises at least:
a porous filter 2, having at least one activated carbon layer allowing the adsorption of organic pollutants during the flow of fluid to be treated,
   the layer(s) being electrically connected to the electrical power supply, in order to polarize them only during electrolysis, the filter 2 being the cathode during electrolysis and the passage of the electrolyte solution allowing regeneration of the filter and removal of organic pollutants;
an anode 6, upstream or downstream of the filter 2, comprising at least one layer of anode material and openings allowing the flow of fluid during filtration and the flow of electrolyte solution during electrolysis,
   the material being electrically connected to the electrical power supply, in order to polarize it as an anode during electrolysis for removal of desorbed organic pollutants from the filter 2,
   the anode 6 and the filter 2 are placed horizontally within the vertically positioned chamber 3, the recirculation circuit 9 ensuring an upward flow of the electrolyte solution within the chamber 3, in order to facilitate the evacuation of gas bubbles formed during electrolysis;
   the reactor 1 operating in two modes:
in continuous filtration mode of a fluid through the circulation circuit 8 for adsorption of pollutants on the filter 2, without an electrical power supply, without water recirculation,
in electrolysis mode, for regeneration of the filter 2 and removal of organic pollutants, by applying an electric current between the filter 2 used as a cathode and the anode 6, with continuous recirculation of the electrolyte solution through the recirculation circuit 9.

The invention provides a second embodiment, a reactor 1 allowing the continuous filtration of flowing fluid for adsorption of pollutants on a filter 2, and the implementation of electrolysis for regeneration of the filter 2 and removal of organic pollutants,

the reactor 1 comprising:
a chamber 3, with at least one inlet 4 delivering a fluid into the chamber 3 and at least one outlet 5 for evacuating the fluid from the chamber 3;
means for supplying electric current to at least one anode 6 and at least one filter 2 used as a cathode;
a circulation circuit 8 for a fluid to be treated by adsorption of pollutants on the filter 2, allowing the passage of the fluid to be treated through the chamber 3;
a recirculation circuit 9 of an electrolyte solution for electrolysis, connecting the outlet 5 to the inlet 4, and passing through an open buffer volume 9a allowing the evacuation of bubbles generated during the electrolysis process,
   wherein all the fluid to be treated and/or the electrolyte solution pass successively through all the elements of the chamber 3 which comprises at least:
a filter 2 comprising at least one activated carbon layer, allowing a liquid fluid to flow through it, the adsorption of pollutants, the passage of gas bubbles formed during electrolysis, the layer(s) being electrically connected to the electrical power supply, in order to polarize it/them, the filter 2 being the cathode during electrolysis allowing regeneration of the filter and removal of organic pollutants.
an anode 6 allowing a liquid fluid to flow through it, the passage of gas bubbles formed during electrolysis if it is placed above the filter 2, comprising at least one layer of anode material making possible the electrolysis of water, the material being electrically connected to the electrical power supply, in order to polarize it as an anode during electrolysis for removal of organic pollutants desorbed from the filter 2,
a separator element 11, located between the anode 6 and the filter 2, allowing the filter 2 used as a cathode and the anode 6 to be electrically connected only by the electrolyte solution during electrolysis,
   the chamber 3 operating in two modes:
in continuous filtration mode of a fluid through the circulation circuit 8 for adsorption of pollutants on the filter 2, without an electrical power supply, without recirculation of the fluid, the anode 6 thus playing no role,
in electrolysis mode, for regeneration of the filter 2 and removal of organic pollutants, by applying an electric current between the filter 2 used as a cathode and the anode 6, with continuous recirculation of the electrolyte solution through the recirculation circuit 9.

The invention provides a third embodiment, a reactor 1 allowing the continuous filtration of flowing water by adsorption of organic pollutants on a filter 2, and the in situ regeneration of the filter 2, comprising:
a filtration and regeneration chamber 3, with at least one inlet 4 delivering the water to be treated containing organic pollutants or an electrolyte solution into the filtration and regeneration chamber 3, and at least one outlet 5 for evacuating the filtered water from the filtration and regeneration chamber 3,
means for supplying electric current to at least one anode 6 and at least one cathode 7.

The reactor 1 also comprises a water circulation circuit 8 for filtration of the water to be treated, and a recirculation circuit 9 of an electrolyte solution for regeneration of the filter, connected to an open buffer volume 9a, used for the evacuation of bubbles generated during regeneration, connecting the outlet 5 to the inlet 4.

The filtration and regeneration chamber 3 consists of:
a filter 2 comprising at least one layer of porous activated carbon fibers allowing the filtration of water and adsorption of organic pollutants on their surface,
which are electrically connected to the electrical power supply, in order to polarize said layer(s), the filter 2 being the cathode 7 for regeneration,
the anode 6 comprising at least one layer of non-active anode material for carrying out the anodic oxidation of organic pollutants, a non-active anode material defined as having an oxygen generation overvoltage higher than 0.4 V compared to the oxygen evolution thermodynamic potential,
the material being electrically connected to the electrical power supply, in order to polarize it as an anode 6, for regeneration, the non-active anode material being configured to allow the water to flow through,
at least one separator element 11 located between the anode 6 and the cathode 7, allowing the cathode 7 and the anode 6 to be electrically connected only by the electrolyte solution

The filtration and regeneration chamber 3 operates in two modes:
in continuous filtration mode of the water to be treated for adsorption of organic pollutants from the water, without electric current, without recirculation of the water,
in regeneration mode, by applying an electric current between the cathode 7 and the anode 6, with continuous recirculation of the electrolyte solution,
to desorb organic pollutants from the surface of the layer of activated carbon fibers, and remove them by electrochemically generated oxidizing species, which mineralize organic pollutants, to regenerate the layer of activated carbon fibers.

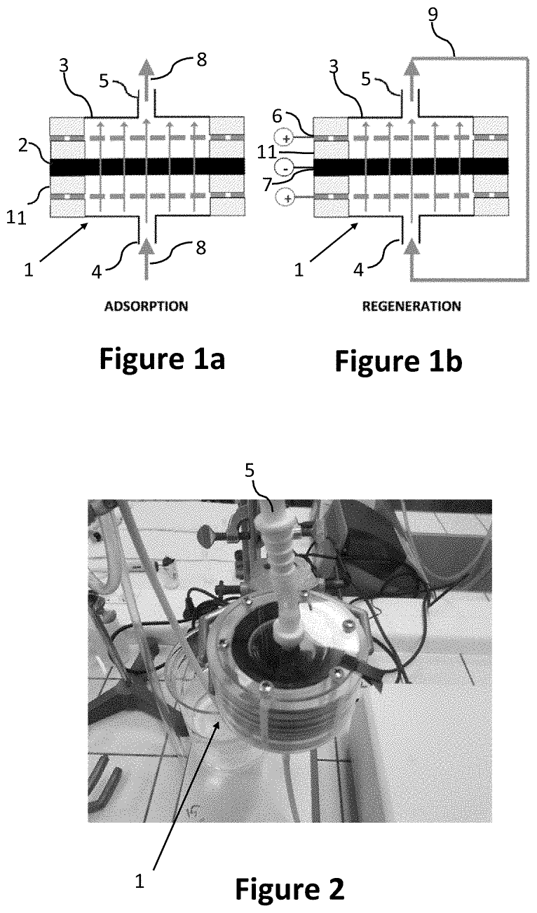

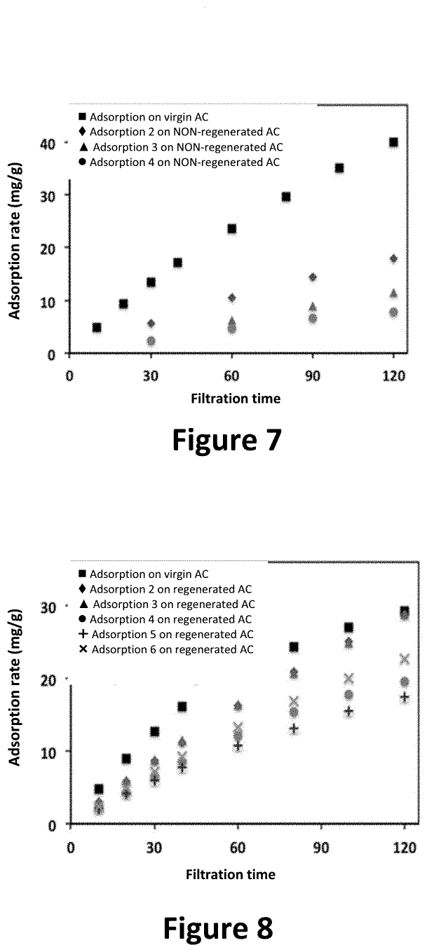

The invention shows for the first time a continuous reactor 1 capable of achieving both:
an efficient continuous adsorption of pollutants contained in water through use of a fixed bed of activated carbon fibers,
the in situ regeneration of these fibers in the same reactor in targeted fashion,
   the removal (degradation/mineralization) of organic pollutants accumulated on the surface of activated carbon fibers, during the regeneration steps,
      as shown in FIGS. 1, 7, 8, 11, 13 and 14.

### Reactor 1

Advantageously, the fluid is a gas or a liquid such as an aqueous liquid.

More advantageously, the fluid is an aqueous liquid.

The reactor 1 can have a single anode 6 downstream of the cathode 7 or have two anodes 6: a first anode 6 located upstream of the cathode 7 and a second anode 6 located downstream of the cathode 7.

The reactor 1 has end walls for the flow, advantageously sufficiently distanced from the anode 6 and the cathode 7, and/or shaped in the form of a truncated cone (truncated cone or funnel): in order to improve hydrodynamics and facilitate the evacuation of gases thereby limiting the presence of bubbles in the reactor.

The end walls can have a channel for the evacuation of gases generated during anodic oxidation.

A reactor with end walls for the flow, sufficiently distanced from the anode and cathode, and/or shaped in the form of a truncated cone: to enhance hydrodynamics and gas evacuation.

Advantageously, the reactor 1 has an anode material 6, a recirculation circuit 9 and hydrodynamics to prevent retention of gas bubbles generated during electrolysis.

Advantageously, the reactor 1 comprises:
the filter 2 with granular activated carbon and/or activated carbon fibers;
the anode 6 comprising a perforated material or a mesh screen on which the anode material is deposited.

Advantageously, the reactor 1 comprising an anode material 6, a filter 2 made of activated carbon fibers and an electrolyte solution formulated to enhance the desorption of pollutants and their removal during electrolysis.

Advantageously, when an electrode placed downstream of another electrode relative to the direction of fluid flow during regeneration is:
the anode 6, thus comprising a perforated material or a mesh screen with openings/mesh greater than 0.15 cm² allowing the passage of gas bubbles formed during electrolysis; or
the filter 2 used as a cathode, the fluid transport system is thus configured to exert pressure on this downstream electrode, thereby enabling the passage of gas bubbles formed during electrolysis, through this downstream electrode.

Advantageously, the mesh screen has openings/mesh greater than 0.20 cm²; 0.25 cm²; 0.30 cm²; 0.35 cm²; 0.40 cm²; 0.45 cm²; or 0.50 cm².

In another embodiment, the reactor 1 is a column reactor 1 which may include separator elements 11 between the anode 6 and the cathode 7, and whose flow is upward. These separator elements must allow the anode and cathode to be electrically connected only by the electrolyte solution. The electrical power supply must not affect the seal of the closed reactor 1.

Advantageously, the chamber 3 comprises several anode 6/filter 2 pairs, connected in series, the two faces of an electrode capable of being polarized during electrolysis.

Advantageously, at least one anode, at least one cathode and means for supplying electric current are included in the open buffer volume 9a, in order to promote the removal of pollutants during electrolysis, such as an anode comprising at least one layer of boron-doped diamond or sub-stoichiometric titanium oxide.

Advantageously, PMMA (polymethyl methacrylate) or PTFE (polytetrafluoroethylene) separators are used and titanium and/or platinum wires and/or foils are used for the electrical power supply.

Advantageously, gaskets are used so that all the elements present in the reactor 1 allow the flow through the anode and cathode materials, without short-circuiting zones (example: overlapping effects).

The anode layer of the reactor 1 is advantageously deposited on a support with openings, wherein the size of the openings allows the flow of water and the evacuation of gas bubbles generated during electrolysis.

The non-active anode layer is a material capable of allowing the flow of water and the evacuation of gas bubbles generated during electrolysis.

Advantageously, the non-active anode layer and/or the support are porous; the anode 6 can either be a 100% non-active material or a deposit on a support.

In one possible embodiment, the non-active anode layer and/or the support has a grid such as a mesh screen, and/or is perforated.

In one possible embodiment, the reactor 1 has a frame 12 that can contain all the layers, the reactor 1 can be dismantled, the layers inside can be changed to replace the layers.

Advantageously, mesh screens are chosen instead of perforated anodes in order to improve hydrodynamics within the cell.

Advantageously, the non-active anode layer and/or the support has spacing between its openings configured to limit the presence of bubbles between the anode 6 and the cathode 7, and to allow in particular the evacuation of gases (H2, O2) formed during anodic oxidation.

For example, the surface of the support (of a mesh screen) is 20 cm².

Advantageously, the surface of the holes is between 20 and 100 mm², more precisely between 30 and 60 mm².

Advantageously, the support has between 60 and 100 holes, more precisely between 70 and 90.

In one possible embodiment, the anode layer is a porous material, which may be a TiOx foam or a TiOx membrane. The foam can have pore size between 60 and 300 μm. The membrane can have pore size between 0.1 and 5 μm.

Advantageously, when the anode layer is a TiOx foam or a TiOx membrane, the electrode placed downstream of another electrode relative to the direction of fluid flow during regeneration, the fluid transport system is thus configured to exert pressure on this downstream electrode, thereby enabling the passage of gas bubbles formed during electrolysis, through this downstream electrode.

In one possible assembly, the reactor 1 has in a body 12, connected in series:
a water inlet,
an initial non-active anode layer resting on an initial support,
a first non-conductive separator element 11, with a gasket, in contact with at least one cathode 7,
the cathode having several layers of porous activated carbon fibers,
a second non-conductive separator element 11, with a gasket in contact with at least the cathode 7,
a second non-active anode layer resting on a second support,
a water outlet.

Advantageously, the reactor includes a control unit 14 connected to solenoid valves in the circulation circuits 8 and recirculation circuits 9, to the fluid transport system and the electrical power supply, so that the filtration or electrolysis operating mode can be set up, by action of the control unit 14 on the circulation circuits 8 and recirculation circuits 9 as well as on the fluid transport system and electrical power supply.

Advantageously, the control unit is able to reverse the direction of circulation flow in the reactor between the passage of fluid in the reactor in filtration mode, and the passage of electrolyte solution in electrolysis mode.

Advantageously, the control unit is connected to a sensor for measuring the concentration of pollutants at the outlet 5, the electrolysis mode being activated when the concentration of pollutants goes above a given value, the filtration mode being activated when the concentration of pollutants goes below a given value.

Advantageously, the fluid transport system is configured to allow the recirculation circuit 9 to reach a fluid filtration speed through the filter 2 greater than 2 m/h.

Advantageously, the fluid filtration speed is higher than 3 m/h; 4 m/h; 5 m/h; 6 m/h; 7 m/h; 8 m/h; 9 m/h; or 10 m/h.

The reactor 1 has two modes of use; advantageously its most common use is the filtration mode.

### Filtration/Adsorption Mode

Compared to a conventional technical solution for electro-oxidation (continuous treatment of an effluent), the invention provides the following advantages:
preconcentration of pollutants on activated carbon fibers before the targeted application of electro-oxidation; this step makes it possible to improve the energy efficiency of the process and thus to reduce energy consumption;
possibility to control the formulation of the electrolyte solution in order to reduce the production of toxic by-products (example: chlorinated by-products when using a conventional solution for electro-oxidation of an effluent containing chloride ions);
possibility to reduce the consumption of electrolyte necessary for passage of the current, due to the implementation of electro-oxidation in targeted fashion only

The use of an activated carbon fiber bed ensures efficient water filtration, while maintaining reduced thickness of the filtration bed.

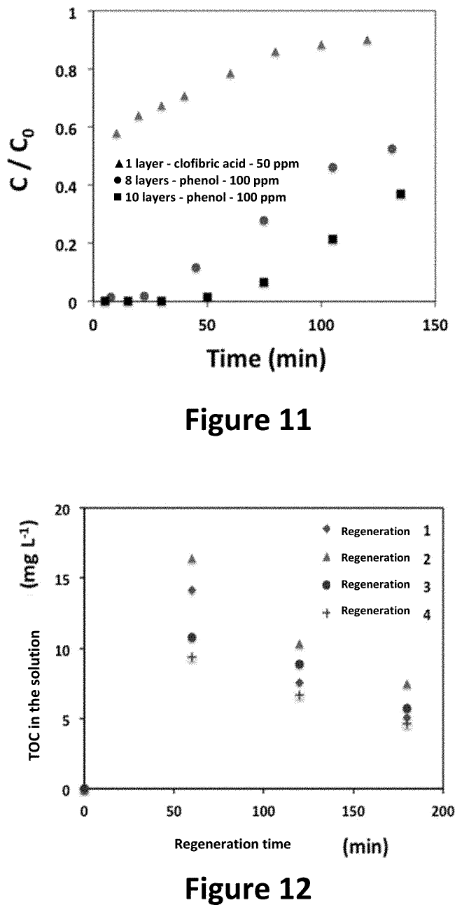

Examples of results are shown in FIG. 11, including the impact of the thickness of the filter 2 (which depends on the number of layers of activated carbon fibers). In this study, clofibric acid and phenol were used as a sample pollutant. This study was carried out with a high concentration of pollutant, in order to reduce the breakthrough time of the filter 2 and to be able to make experimental observations on the scale of 2-3 days at most. There is a complete removal of pollutants with these high concentrations, from the use of only 8 layers of fibers, i.e., a filter bed thickness of only 4 mm.

### The Fiber Layer/Filter 2

In one possible embodiment, at least one activated carbon layer is formed of activated carbon fibers.

In another possible embodiment, at least one activated carbon layer is formed of granular activated carbon.

Compared to a conventional technology solution for activated carbon adsorption, the invention has the following advantages:
possibility to benefit from the characteristics of activated carbon fibers (in order to overcome the limitations of granular and powdered AC) and to implement compact reactors (reduced thickness of filtration beds);
possibility to reduce the quantity of adsorbent material used (due to regeneration).

The reactor 1 can have several superimposed layers of activated carbon fibers.

Advantageously, the porous fibers are made of felt or fabric.

Advantageously, at least one activated carbon layer has a specific surface area greater than 600 m2·g−1 and the porous fibers have a porosity such that more than 30% of the pore volume of each of the porous fibers consists of pores smaller than 2 nm.

The layer of activated carbon fibers has a thickness between 0.3 and 20 cm (the thickness of this layer depends on the number of sub-layers of carbon fibers used).

TABLE 1
Primary characteristics of activated carbon fibers used

| | | Average | Surface | Porous volue (cm³ g⁻¹) - Distribution of pore size | | | | |
|---|---|---|---|---|---|---|---|---|
| Weight | Thickness | pore size | BET | Microporous | Microporous | Mesoporous | Macroporous | |
| (g m−2) | (mm) | (mm) | (m² g⁻¹) | (<1 nm) | (1-2 nm) | (2-20 nm) | (>20 nm) | Total |
| 90 | 0.5 | 0.82 | 1306 | 65% | 33% | 1.7% | 0.2% | 0.54 |

### Water Inlet 4/Outlet 5

Advantageously, the filtration speed (ratio between water flow rate and surface of the filter 2) is between 0.2 m/h and 5 m/h, in filtration mode, and between 2 and 20 m/h in regeneration mode.

In one possible embodiment, the outlet 5 has a conical shape (point downstream of the flow), to facilitate gas evacuation.

In one possible embodiment, the inlet 4 has a conical shape (point upstream of the flow), to distribute the water on the surface of the activated carbon fiber layer(s).

In another embodiment, the reactor 1 has a new outlet 5 located between the anode 6 and the cathode 7, advantageously used during regeneration. In this embodiment, the electrolyte solution flows from the inlet 4 to the new outlet 5, and from the old outlet 5 (becoming a new inlet 4) to the new outlet 5.

In another embodiment, a sensor 13 is added, to allow the quantity of organic pollutants at the inlet 4 and outlet 5 to be measured, in order to calculate a filtration efficiency percentage.

Advantageously, the reactor 1 switches to regeneration mode when the filtration efficiency percentage reaches preferably less than 95%.

Advantageously, the threshold is adjustable, making possible an automatic change in operating mode.

### Regeneration Mode

In this operating mode, the circulation of incoming water (to be filtered) is cut off, in order to use a continuously recirculated electrolyte solution. The electrolyte solution originates from an open buffer volume.

In order to regenerate the filter 2 (activated carbon layers), an electric current is passed through at least one activated carbon layer and through the anode material layer, forming a cathode 7 and an anode 6 respectively.

With this regeneration mode and the invention:
possibility to regenerate activated carbon fibers several times in situ, in order to obtain the initial adsorption capacity, as shown in FIG. 8;
minimization of handling and elimination of the need to transport used adsorbent material;
possibility of complete removal of pollutants (mineralization);
targeted application of the electro-oxidation process (after adsorption); this allows a significant reduction in electrolyte consumption (salts can be added to increase water conductivity and reduce energy consumption), compared to continuous application of the electro-oxidation process. The high concentration of pollutants on activated carbon fibers also improves the energy efficiency of the electro-oxidation process, compared to conventional continuous application on the less concentrated water to be treated. The electrolyte formulation can be chosen in order to select the oxidizing species to be generated and avoid the formation of toxic compounds.

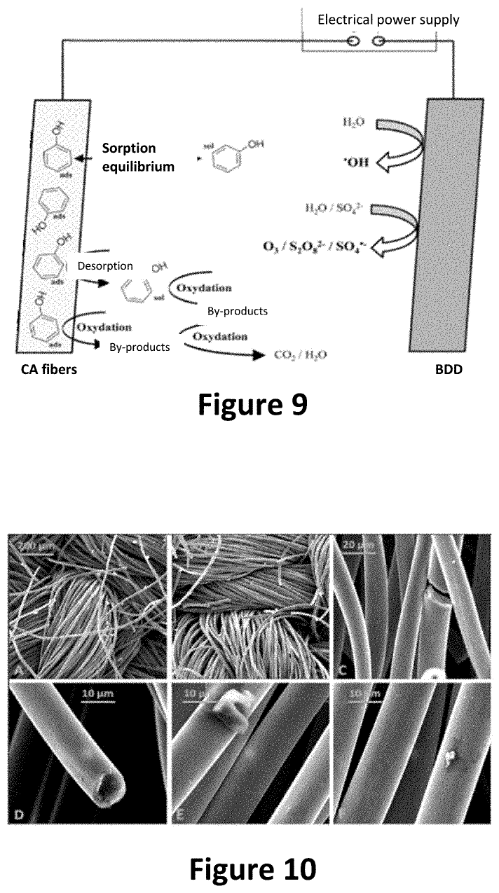

Regeneration works by different mechanisms:
desorption of pollutants from the cathode 7; this desorption is accelerated by polarization as the cathode 7 of the material and the high local pH at the cathode 7 (electrostatic interactions);
formation of oxidizing species, primarily at the anode 6 (mainly hydroxyl radicals, persulfates, sulfate radicals), but also at the cathode (hydrogen peroxide, sulfate radicals), for the degradation and mineralization of desorbed pollutants, as shown in FIG. 9;
degradation and mineralization of desorbed pollutants in the solution allowing a continuous shift in the sorption equilibrium and thus continuous desorption of adsorbed compounds;
direct oxidation of adsorbed compounds by the electrochemically formed oxidizing species.

To perform the regeneration, an electrolyte solution is circulated in the filtration chamber 3. The electrolyte solution circulates in the recirculation circuit 9, the solution is not discarded, it is reused and circulates in a loop in the recirculation circuit 9 and in the chamber 3, until the filter 2 has only a limited quantity of organic pollutants left.

In one possible embodiment, the recirculation circuit 9 has a receptacle comprising an open buffer volume 9a of electrolyte solution. During regeneration of the filter, the receptacle supplies electrolyte solution from the buffer volume 9a flowing from the inlet 4 of the filtration chamber 3, and the receptacle collects the electrolyte solution through the outlet 5 of the filtration chamber 3. The bubbles formed during regeneration are transported by the electrolyte solution as it flows through the recirculation circuit 9. The bubbles are evacuated into the buffer volume 9a, with an air exchange system or by direct contact with the air.

In one possible embodiment, the buffer volume 9a has an anode 6 and a cathode 7, participating in the removal of desorbed compounds (organic pollutants) by electro-oxidation during regeneration, allowing the regeneration time to be reduced. Different electrode materials can be used, depending on the nature of the desorbed compounds to be removed.

In one example of use, a sensor 13 makes it possible to track the mineralization of desorbed pollutants, during regeneration cycles, FIG. 12 shows the results. Firstly, an increase in the concentration of TOC is observed, resulting from the rapid initial desorption of pollutants. The TOC concentration then decreases, resulting from the mineralization of pollutants in the solution, owing to the oxidizing species that are generated primarily at the anode 6 (anodic oxidation).

Advantageously, the sensor 13 measures UV absorbance in water at the inlet 4 and outlet 5.

In another possible embodiment, the sensor 13 measures the Total Organic Carbon (TOC) concentration in water.

### The Electrolyte Solution

Advantageously, the electrolyte solution is a 50-mM sodium sulfate solution. This solution prevents the formation of toxic by-products, as is the case in the presence of chlorides.

Advantageously, the electrolyte solution contains only sodium sulfate.

More advantageously, the electrolyte solution is iron-free and/or oxygen-free.

Advantageously, the electrolyte solution's pH is adjusted to improve pollutant desorption.

Advantageously, the electrolyte solution's pH is adjusted to improve the desorption of pollutants at a pH higher than 8; 9; 10; 11; 12; 13.

Advantageously, peroxymonosulfate and/or peroxodisulfate ions are produced at the anode, by oxidation of sulfate ions, to promote filter regeneration and/or removal of organic pollutants.

Advantageously, peroxymonosulfate and/or peroxodisulfate ions are activated in the activated carbon filter used as a cathode, to form oxidizing species to facilitate filter regeneration and/or removal of organic pollutants.

Advantageously, peroxymonosulfate and/or peroxodisulfate ions are added to the electrolyte solution, to facilitate filter regeneration and/or removal of organic pollutants.

In another embodiment, the electrolyte solution contains iron source and bubbled air in order to promote, in addition to anodic oxidation, the electro-Fenton process (formation of H₂O₂ and Fe²⁺ at the cathode allowing the formation of hydroxyl radicals via the Fenton reaction).

### Examples/Uses of the Reactor 1

The invention has advantages, including high process efficiency attributed to
(i) the direct oxidation of phenol (PH) adsorbed by the hydroxyl radicals generated,
(ii) the continuous shift in adsorption equilibrium due to oxidation of organic compounds in the solution and the reaction at the anode and
(iii) the local increase in pH at the cathode 7 leading to repulsive electrostatic interactions.

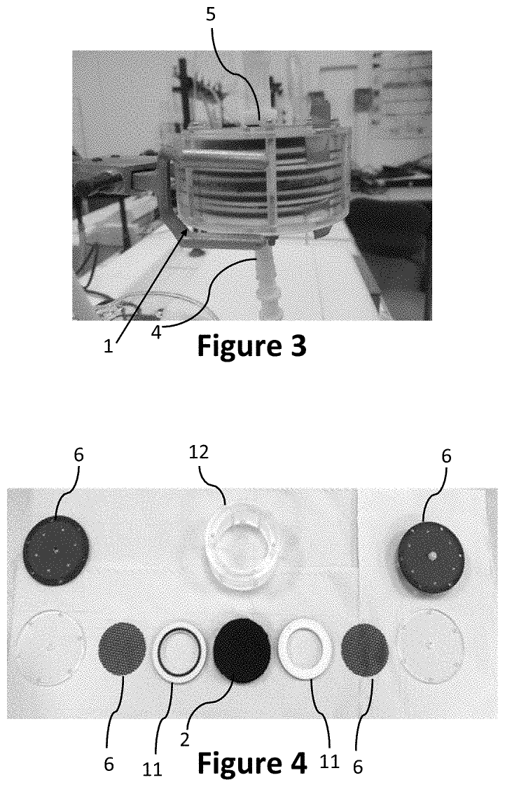

One example of a possible configuration of the reactor 1 is a stack made up of an anode 6, as shown in FIG. 4, which is composed of a layer of perforated Niobium (Nb) covered with boron-doped diamond, then the separator 11 consisting of a non-conductive Teflon layer, the filter 2 consisting of layers of activated carbon fibers, another separator 11 consisting of a non-conductive Teflon layer, and finally another anode composed of a layer of perforated Niobium covered with boron-doped diamond, all surrounded by polymethyl methacrylate housing.

One example of a possible configuration comprises a non-conductive polymethyl methacrylate element, a boron-doped diamond-coated Nb mesh screen, then a non-conductive Teflon layer, a layer of activated carbon fibers, a non-conductive Teflon layer, a boron-doped diamond-coated Nb mesh screen, and finally a non-conductive polymethyl methacrylate element, all surrounded by polymethyl methacrylate housing.

An example of the operating conditions of the reactor 1 during regeneration:
use of a “sandwich” configuration, with two boron-doped diamond perforated planar electrodes on either side of the activated carbon fabric to be regenerated;
operating conditions: I=750 mA; flow rate=0.9 L/h; volume of solution used and continuously recirculated=150 mL; pH=3; [Na2SO4]=50 mM; [Fe]=0.15 mM; continuous bubbling of air into the solution; treatment time 3 hours.

Operating conditions during filtration: 1 single layer of activated carbon fibers (diameter=5.5 cm); flow rate=0.9 L/h; clofibric acid concentration=55 mg/L.

Another example of operating conditions during regeneration:
use of a “sandwich” configuration, with two boron-doped diamond mesh electrodes on either side of the bed of activated carbon fibers to be regenerated (10 layers), separated by non-conductive Teflon layers;
operating conditions: I=600 mA; flow rate=4.0 L/h; volume of solution used and continuously recirculated=400 mL; natural pH; [Na2SO4]=50 mM; [Fe]=0 mM; no bubbling; treatment time 36 hours.

Operating conditions during filtration: 10 layers of activated carbon fibers (diameter=5.5 cm); flow rate=2.0 L/h; phenol concentration=100 mg/L.

Another example of operating conditions during regeneration:
use of a “sandwich” configuration, with two boron-doped diamond mesh electrodes (BDD diameter 5 cm, large mesh) on each side of the activated carbon fiber bed to be regenerated (10 layers, diameter 5 cm), separated by layers of non-conductive polymethyl methacrylate;
a boron-doped diamond anode and a stainless steel cathode are placed in the buffer volume for recirculation. The intensity of the current is 300 mA in the buffer volume and 300 mA in the chamber. The filtration rate of the electrolyte solution is 5 m/h. The electrolyte solution contains 50 mM Na₂SO₄ and pH is adjusted to 13 with NaOH.
operating conditions: I=300 mA in the chamber and I=300 mA in the buffer volume for recirculation; flow rate=10.0 L/h; volume of solution used and continuously recirculated=2 L; pH 13; [Na2SO4]=50 mM; [Fe]=0 mM; no bubbling.
operating conditions during filtration: 10 layers of activated carbon fibers (diameter=5 cm); flow rate=2.0 L/h; phenol concentration=10 mg/L.

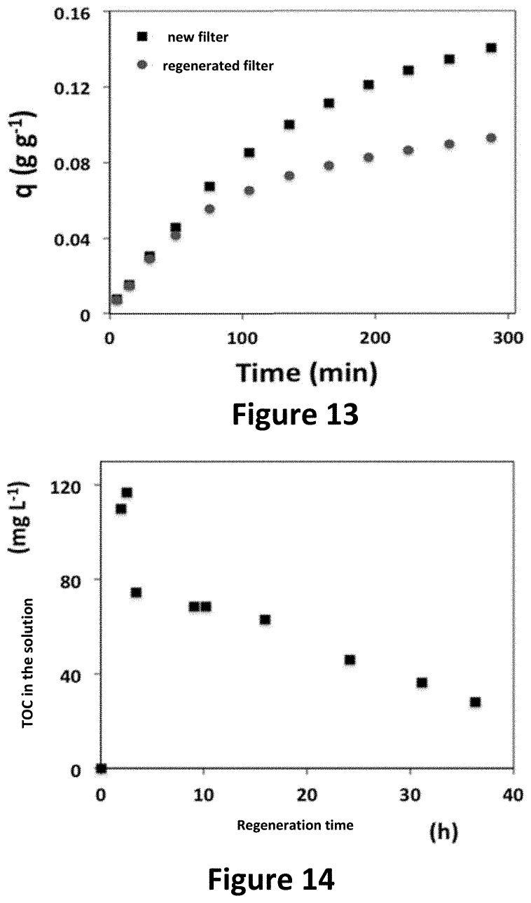

In studies on the invention's possible operating conditions, the results shown in FIG. 13 demonstrate that a regeneration step by anodic oxidation (without the use of electro-Fenton) can obtain a significant portion of the initial adsorption capacity of the filter 2. The results shown in FIG. 14 and the decrease in TOC in the solution during regeneration show that it is also possible to mineralize desorbed compounds. The results in FIGS. 20, 21 and 22 also show that the regeneration step makes it possible to obtain the filter's adsorption capacity and completely degrade and mineralize desorbed pollutants.

### System 10 Using the Reactor 1

The reactor 1 described in the invention can be used in a water filtration system 10 comprising at least one reactor 1, and a water flow system connected to the inlet 4 and the outlet 5.

Advantageously, the fluid recirculation circuits 9 of the reactors 1 are connected, so as to present a shared open buffer volume 9a.

Advantageously, the reactors 1 are placed in series or in parallel, with respect to the flow of fluid to be treated.

The water flow system can be configured, and/or the reactor 1 rotated by 180 degrees, so that the flow is reversed between adsorption mode and regeneration mode.

Advantageously, the water flow system is configured so that the filtration speed (ratio between water flow rate and surface of the filter 2) is between 0.2 m/h and 5 m/h, in filtration mode, and between 0.2 and 20 m/h in regeneration mode.

In one possible embodiment, several column reactors 1 are arranged so that they can be in regeneration mode in at least one reactor 1, while the other reactors 1 are in adsorption mode.

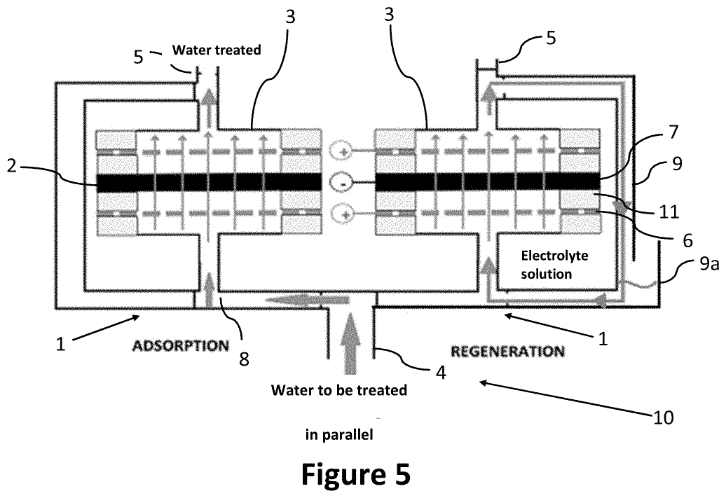

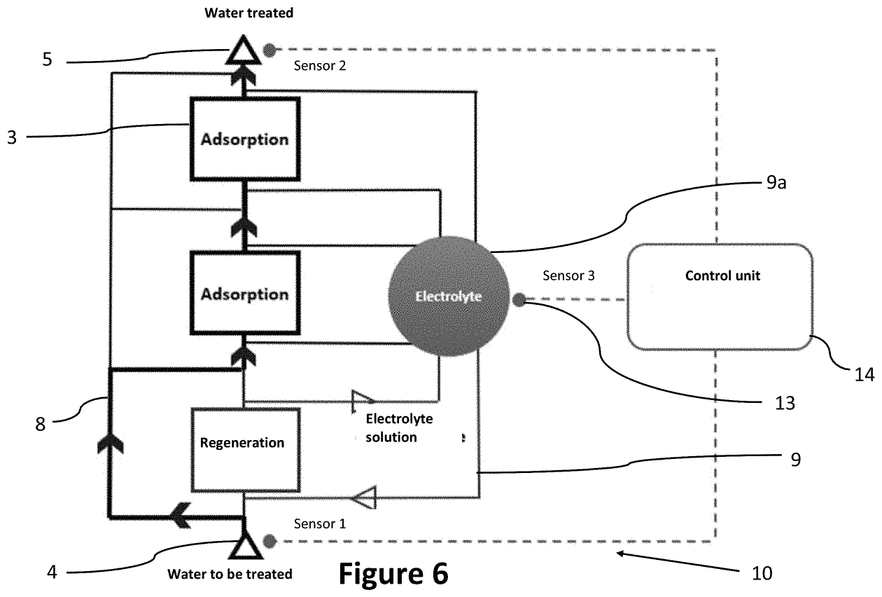

The reactors 1 can be arranged in parallel (FIG. 5) or/and in series (FIG. 6), and always with a water flow system allowing continuous water filtration, even when a reactor 1 is in regeneration mode.

Advantageously, it is the overall quality of water at the outlet that is measured, in order to be able to measure the quantity of organic pollutants at the outlet. Advantageously, when the quality of water at the outlet drops, a clean/regenerated filter (which was previously used more for adsorption) is reactivated and a dirty filter is regenerated.

Advantageously, the system 10 includes several sensors 13. The system 10 can have one sensor 13 at the inlet 4 of the system 10 and a second sensor 13 at the outlet 5 of the system 10.

In another embodiment, the system 10 has a sensor 13 at each inlet 4 and each outlet 5 of the reactors 1 present in the system 10.

Advantageously, all the inlets 4 and all the outlets 5 of the reactors 1 present in the system 10, are connected to the buffer volume 9a, thus forming the recirculation circuit.

Advantageously, all the sensors 13 in the system 10 are connected to a control unit 14, making it possible to modify the circulation of water to be filtered in the system 10, by means of valves, in order to allow some reactors to be in regeneration mode, depending on the quantity of outgoing organic pollutants. The control unit 14 regulates the water circuit, ensuring that the electrolyte solution contained in the buffer volume 9a does not mix with the water to be filtered. The control unit 14 controls the means for supplying electric current to the anodes 6 and cathodes 7.

Advantageously, the control unit 14 collects the following information: the quality of water to be treated, the quality of treated water, the quality of the electrolyte (for example with UV absorbance sensors 13), and the control unit 14 activates the valves (hydraulic circuit), regulates the intensity of the current for regeneration and controls the electrical power supply.

The column reactors 1 can go into regeneration mode when the filters 2 allow at least 5% of organic pollutants to pass through.

Advantageously, the filtration/regeneration system 10 is capable of treating at least ten liters per hour.

### Results

I—on the Anode 6 Material, the Recirculation Circuit 9 and Hydrodynamics Prevent the Retention of Gas Bubbles Generated During Electrolysis

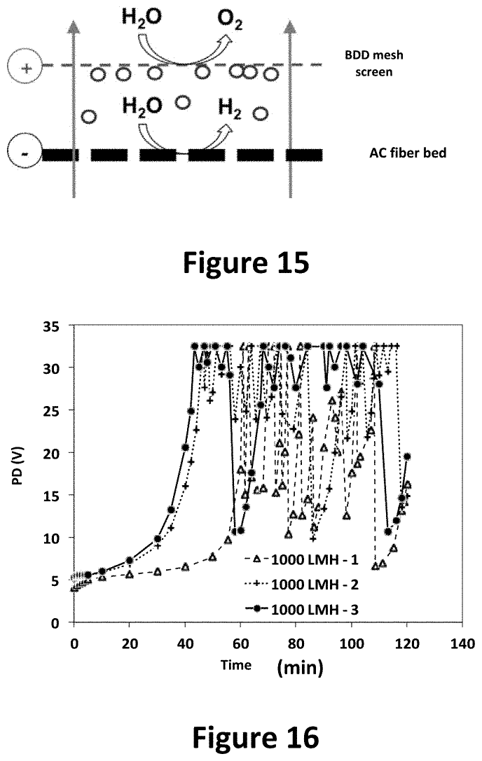

The problem of gas retention in the inter-electrode space during electrolysis arises from the generation of O₂ bubbles and H₂ bubbles during water oxidation at the anode and its reduction at the cathode, respectively. Depending on hydrodynamic conditions and the nature of electrode materials used, the gas bubbles formed on electrodes may not be able to pass through the electrode situated above where they are produced. This can lead to a buildup of gas at the top electrode. Since a gas is an electrical insulator, these bubbles constitute high resistance to the flow of current. This accumulation of gas will reduce the electrode's electroactive surface (only the part of the electrode's surface where there is no accumulation of gas will remain active) and will greatly increase the potential difference (PD) between the two electrodes. This problem is represented schematically in FIG. 15.

An initial series of tests consisted in monitoring the potential difference in the reactor, during the electrolysis process. The first configuration tested consisted of a stack made up of an activated carbon fiber bed (below) and a mesh BDD screen with tight mesh (above), as in FIG. 15. The tight mesh in this mesh screen is diamond-shaped with the following dimensions: large diagonal: 6 mm, small diagonal: 3.7 mm. This represents an area of 0.11 cm².

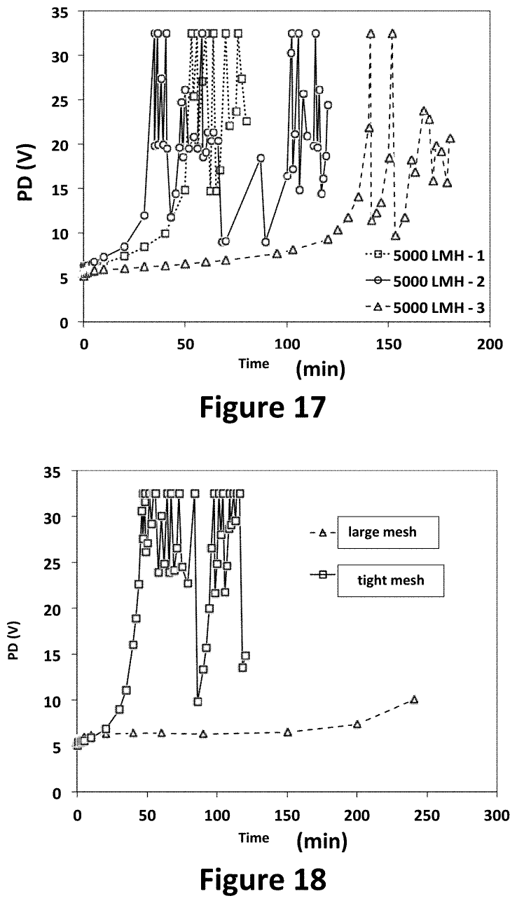

FIG. 16 shows the results obtained in three different tests conducted with a flow of 1000 L/m⁻²/h⁻¹, i.e., a filtration rate of 1 m/h⁻¹. FIG. 17 shows the results obtained in three different tests, conducted with a flow of 5000 L/m⁻²/h⁻¹, i.e., a filtration rate of 5 m/h⁻¹. A rapid increase in PD is observed, due to the retention of gas in the inter-electrode space, notably by the retention in the tight mesh BDD screen of gas bubbles formed at the cathode. A fluctuation is then observed, due to the periodic release of a few gas bubbles when too many have accumulated. However, the PD remains overall at a very high level. As observed in FIG. 17, increasing the filtration rate does not significantly solve this problem. It should be noted that these results were not expected. Indeed, the size of this tight mesh is still much larger than the size of the (micro)bubbles generated at the electrodes. However, the interaction of bubbles with the material's surface and the phenomena of bubble coalescence result in this detrimental effect for the process.

In order to solve this problem, the use of a mesh BDD screen with larger mesh was tested, in FIG. 18. The larger mesh in this mesh screen is diamond-shaped with the following dimensions: large diagonal: 12.5 mm, small diagonal: 7.3 mm. This represents a free surface of 0.46 cm². The results of this test are shown in FIG. 18. Use of this mesh BDD screen with a larger mesh size prevents the accumulation of bubbles on the mesh BDD screen. The gas bubbles are able to pass through this material, without accumulating. Use of this mesh screen therefore solves the problem of gas retention when the anode material is placed above the activated carbon filter.

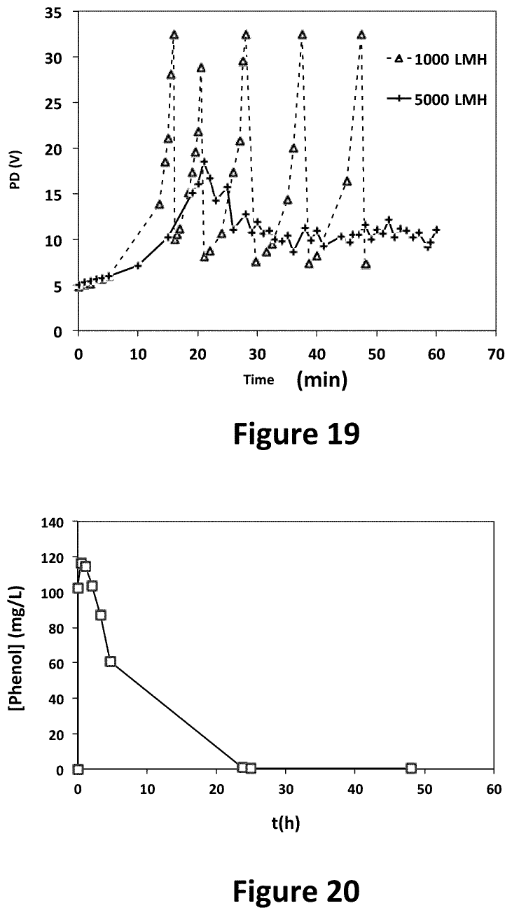

Another series of tests related to another configuration, consisting of a stack made up of a tight mesh BDD screen (below) and a bed of activated carbon fibers (above). In this case, the major problem is the accumulation of bubbles (formed on the mesh BDD screen), in the activated carbon fiber bed. In this case, it is not possible to significantly alter the nature of the activated carbon fiber bed, and in particular its porosity, because this is the key element in the adsorption step. In this case, where the nature of the material cannot be modified, a solution was sought instead in the process's operating conditions. It was found that by increasing the flow of electrolyte solution through the filter, it was possible to avoid too much bubble accumulation in the fibers, and thus too large of an increase in PD. These results are shown in FIG. 19. A filtration rate of 1 m/h⁻¹ causes a sharp increase in PD, then a fluctuation, due to the periodic release of a few gas bubbles when too many have accumulated. This operation is not viable for application of the process. However, by increasing the filtration rate to 5 m/h⁻¹, it is then possible to stabilize the increase at a viable value of approximately 10 V. The filtration rate (i.e., the flow) of electrolyte solution is therefore a key operating parameter, making it possible to prevent gas retention in the activated carbon fiber bed when it is located above a counter-electrode. This is explained by an increase in pressure in the filter, allowing the passage of gas bubbles through it. Other parameters could affect this pressure in the filter, such as thickness of the activated carbon bed, or the nature (notably the porous structure) of the bed itself. The porous structure of the activated carbon bed could also alter the pressure required to facilitate the passage of bubbles through it.

II—on the Composition of the Electrolyte Solution (Especially the Adjustment of the pH)

Tests have shown that the adjustment of the pH of the solution could strongly improve the efficiency of the process.

The idea is to enhance the desorption of compounds adsorbed at the cathode, by electrostatic repulsion during electrolysis. Indeed, at a basic pH, the pollutants will be in deprotonated form (negatively charged), which will promote the phenomena of electrostatic repulsion when the activated carbon filter is polarized as a cathode (negative potential). By facilitating desorption, the removal of compounds is also enhanced, because the electro-oxidation process is more energy-efficient when higher concentrations of organic compounds are reached in the solution (less limitation by the transport of matter).

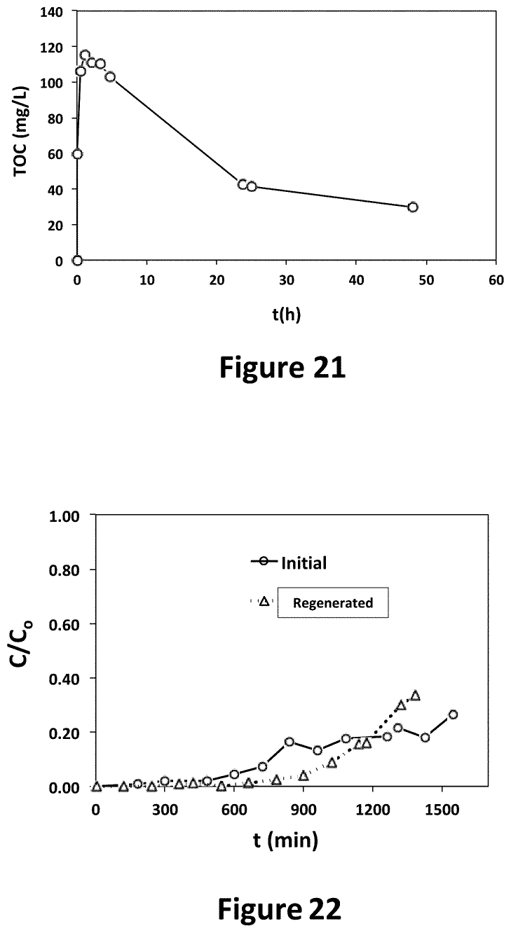

The results in FIGS. 20 and 21 show the evolution of phenol and total organic carbon concentration, respectively, during regeneration. A 10-layer activated carbon fiber filter was used. A mesh BDD screen-type anode (large mesh size) is placed downstream of the filter, another one upstream. The filtration surface area was 19.6 cm². A BDD anode and a stainless steel cathode are placed in the buffer volume for recirculation. The current intensity is 300 mA in the buffer volume and 300 mA in the chamber. The filtration rate of the electrolyte solution is 5 m/h. The electrolyte solution contains 50 mM Na₂SO₄ and its pH is adjusted to 13 with NaOH. The adsorption step was performed with a phenol concentration of 10 mg/L and a flow rate of 2 L/h.

An increase in phenol and organic carbon concentrations was observed, when the desorption phenomena were predominant, followed by a decrease due to degradation and mineralization in the solution of desorbed compounds. The results in FIG. 20 show that the filter's adsorption capacity for phenol was fully restored through this regeneration step.

1. A reactor allowing the continuous frontal filtration of a flowing fluid for adsorption of pollutants on a filter and electrolysis for regeneration of the filter and removal of organic pollutants,
the reactor comprising:
a chamber, with at least one inlet delivering a fluid into the chamber and at least one outlet for evacuating the fluid from the chamber;
means for supplying electric current;
a circuit for circulating a fluid to be treated by adsorption of pollutants on the filter, allowing the passage of the fluid to be treated through the chamber;
a recirculation circuit of an electrolyte solution for electrolysis, connecting the outlet to the inlet, and passing through an open buffer volume allowing the evacuation of gas bubbles generated during electrolysis;
a fluid transport system;
all the fluid to be treated as well as the electrolyte solution pass successively through all the elements of the chamber which comprises at least:
a porous filter, having at least one activated carbon layer allowing the adsorption of organic pollutants during the flow of fluid to be treated,
the layer(s) being electrically connected to the electrical power supply, in order to polarize them only during electrolysis, the filter being the cathode during electrolysis and the passage of the electrolyte solution allowing regeneration of the filter and removal of organic pollutants;
an anode, upstream or downstream of the filter, comprising at least one layer of anode material and openings allowing the flow of fluid during filtration and the flow of electrolyte solution during electrolysis,
the material being electrically connected to the electrical power supply, in order to polarize it as an anode during electrolysis for removal of desorbed organic pollutants from the filter,
the anode and the filter are placed horizontally within the vertically positioned chamber, the recirculation circuit ensuring an upward flow of the electrolyte solution within the chamber, in order to facilitate the evacuation of gas bubbles formed during electrolysis;
the reactor operating in two modes:
in continuous filtration mode of a fluid through the circulation circuit for adsorption of pollutants on the filter, without an electrical power supply, without water recirculation,
in electrolysis mode, for regeneration of the filter and removal of organic pollutants, by applying an electric current between the filter used as a cathode and the anode, with continuous recirculation of the electrolyte solution through the recirculation circuit.

2. Reactor according to claim 1, wherein the anode comprises a perforated material or a mesh screen on which the anode material is deposited.

3. Reactor according to claim 1, wherein an electrode placed downstream of another electrode relative to the direction of fluid flow during regeneration is:
the anode, thus comprising a perforated material or a mesh screen with openings/mesh greater than 0.15 cm² allowing the passage of gas bubbles formed during electrolysis; or
the filter used as a cathode, the fluid transport system is thus configured to exert pressure on this downstream electrode, thereby enabling the passage of gas bubbles formed during electrolysis, through this downstream electrode.

4. Reactor according to claim 1, wherein the reactor comprises an anode material made of boron-doped diamond or sub-stoichiometric titanium oxide allowing the removal of organic compounds.

5. Reactor according to claim 1, wherein at least one activated carbon layer is formed of activated carbon fibers.

6. Reactor according to claim 1, wherein at least one activated carbon layer is formed of granular activated carbon.

7. Reactor according to claim 1, wherein the chamber comprises several anode (6)/filter pairs, connected in series, the two faces of an electrode being polarizable during electrolysis.

8. Reactor according to claim 1, wherein at least one anode, at least one cathode and the electrical power supply are included in the open buffer volume in order to facilitate the removal of pollutants during electrolysis,
such as an anode comprising at least one layer of boron-doped diamond or sub-stoichiometric titanium oxide.

9. Reactor according claim 1, wherein the pH of the electrolyte solution is adjusted to a pH higher than 9, in order to promote the desorption of pollutants during electrolysis.

10. Reactor according to claim 1, including a control unit connected to solenoid valves in the circulation circuits and recirculation circuits, to the fluid transport system and the electrical power supply, so that the filtration or electrolysis operating mode can be set up, by action of the control unit on the circulation circuits and recirculation circuits as well as on the fluid transport system and electrical power supply.

11. Reactor according to claim 1, wherein the fluid transport system is configured to allow the recirculation circuit to reach a filtration rate of electrolyte solution through the filter greater than 2 m/h during electrolysis.

12. Reactor according to claim 1, wherein the control unit is able to reverse the direction of circulation flow in the reactor between the passage of fluid in the reactor in filtration mode, and the passage of electrolyte solution in electrolysis mode.

13. Reactor according to claim 10, wherein the control unit is connected to a sensor for measuring the concentration of pollutants at the outlet, the electrolysis mode being activated when the pollutant concentration goes above a given value, the filtration mode being activated when the pollutant concentration goes below a given value.

14. Reactor according to claim 1, wherein the fluid is a gas or a liquid such as an aqueous liquid.

15. System comprising several reactors according to claim 1.

16. System according to claim 15, wherein the fluid recirculation circuits of the reactors are connected, so as to provide a shared open buffer volume.

17. System according to claim 15, wherein the reactors are placed in series or in parallel with respect to the flow of the fluid to be treated.
